(19) United States
(12) Patent Application Publication
(10) Pub. No.: US 2021/0105953 A1
(43) Pub. Date: Apr. 15, 2021

(54) APPARATUS FOR CLEANING A TREE TRUNK

(71) Applicant: John Cheney, Port Orange, FL (US)

(72) Inventor: John Cheney, Port Orange, FL (US)

(21) Appl. No.: 16/601,765

(22) Filed: Oct. 15, 2019

(51) Int. Cl. A01G 7/06; B08B 3/02; B05C 17/00; B05C 5/02; A01G 17/00

(52) U.S. Cl. CPC A01G 7/06; B08B 3/026; A01G 17/00; B05C 5/0241; B05C 5/027; B05C 17/002

(57) ABSTRACT

An apparatus for cleaning the trunk of a tree is disclosed. The apparatus comprises a pressure washer in fluid communication with a water source and a conduit in fluid communication with the pressure washer to receive a flow of pressurized water expelled therefrom. The conduit is arranged in at least a semi-circle to at least partially extend around the diameter of a tree trunk. A plurality of spray nozzles is disposed along the conduit to expel pressurized water from the conduit to clean the tree trunk. A barrier is connected to the conduit to impede the pressurized water from travelling in an undesired direction.

### TECHNICAL FIELD

The embodiments generally relate to agricultural equipment and more specifically relate to equipment for cleaning a tree trunk.

### BACKGROUND

Phoenix dactylifera, commonly referred to as “date palm,” is a flowering plant species in the palm family. The tree is often cultivated for its edible sweet fruit but in recent years has been planted for its aesthetic appeal. The date palm can reach heights of 69-75 feet, growing singly or forming a clump with several trunks from a single root system. Another tree in the palm family is the Phoenix roebelenii, commonly known as the “miniature date palm.” Unlike P. dactylifera, the miniature date palm only reaches heights of 6-10 feet, but often has multiple trunks extending from a single root system.

Date palms and miniature date palms which are planted for aesthetic appeal require their trunks to be cleaned or cut to maintain a desirable appearance. It is often desirable for the trees to retain the diamond-shaped scar pattern on the trunk of the tree. Over time, the dried leaf stalks, petioles, moss, dirt and other debris build up on the trunk and cover the natural diamond pattern.

In the current arts, to maintain a desirable appearance of the date palm trees, maintenance personnel use a chainsaw to cut away the dried leaf stalks, petioles, moss, dirt, and other debris to reveal the diamond-shaped scarring on the trunk. This requires a human to operate dangerous equipment while moving up and down the height of the tree, further posing risk to the operator.

### SUMMARY OF THE INVENTION

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

An apparatus for cleaning the trunk of a tree is disclosed. The apparatus comprises a pressure washer in fluid communication with a water source and a conduit in fluid communication with the pressure washer to receive a flow of pressurized water expelled therefrom. The conduit is arranged in at least a semi-circle to at least partially extend around the diameter of a tree trunk. A plurality of spray nozzles are disposed along the conduit to expel pressurized water from the conduit to clean the tree trunk. A barrier is connected to the conduit to impede the pressurized water from traveling in an undesired direction.

In one aspect, the conduit is comprised of a first end and a second end, the first end having a male coupler and the second end having a female coupler. Each coupler facilitates the connection between one or more conduits to lengthen the conduit, or to utilize the conduit in a semi-circular configuration.

In one aspect, the apparatus is operable in a semi-circular and circular configuration by connecting one or more of the conduits in series via the male and female couplers.

In one aspect, an extendable member connects the conduit to the pressure washer to permit the user to raise and lower the apparatus up and down the height of the tree trunk.

In one aspect, the top portion of the barrier is constructed of a rigid material, and the bottom portion of the barrier is constructed of a flexible material. Each portion may be constructed of a transparent material.

In one aspect, the pressure washer and/or a water source is mounted to a vehicle such as a service truck. The vehicle may include a lift to lift and lower an operator and/or the conduit system up and down the tree trunk.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a top plan view of the conduit and couplers disconnected from one another, according to some embodiments;

FIG. 2 illustrates a top plan view of the conduit and couplers connected to form a circular configuration, according to some embodiments;

FIG. 3 illustrates an exploded view of the conduit and coupler components, according to some embodiments;

FIG. 4 illustrates a perspective view of the conduit and barrier arranged in a semi-circular configuration, according to some embodiments;

FIG. 5 illustrates a perspective view of the conduit and tree guides, according to some embodiments;

FIG. 6 illustrates an exploded view of the apparatus, according to some embodiments; and

FIG. 7 illustrates a perspective view of the apparatus in a semi-circular configuration to clean the trunk of a tree, according to some embodiments.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood therefrom.

Before describing in detail exemplary embodiments, it is noted that the embodiments reside primarily in combinations of components and procedures related to the system and method. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments herein relate to an apparatus to facilitate the removal of debris to clean the trunk of a tree, such as a date palm, miniature date palm, or other trees which may benefit from cleaning of the trunk to produce the desired appearance. The apparatus utilizes pressurized water to dislodge dried leaf stalks, petioles, moss, dirt and other debris build up on the trunk of the tree. For example, the apparatus may be used to restore the natural “diamond scar” appearance found on the date palm and miniature date palm.

The embodiments provide for a water source, such as the municipal water supply or a water tank, to provide a flow of water to a pressure washer.

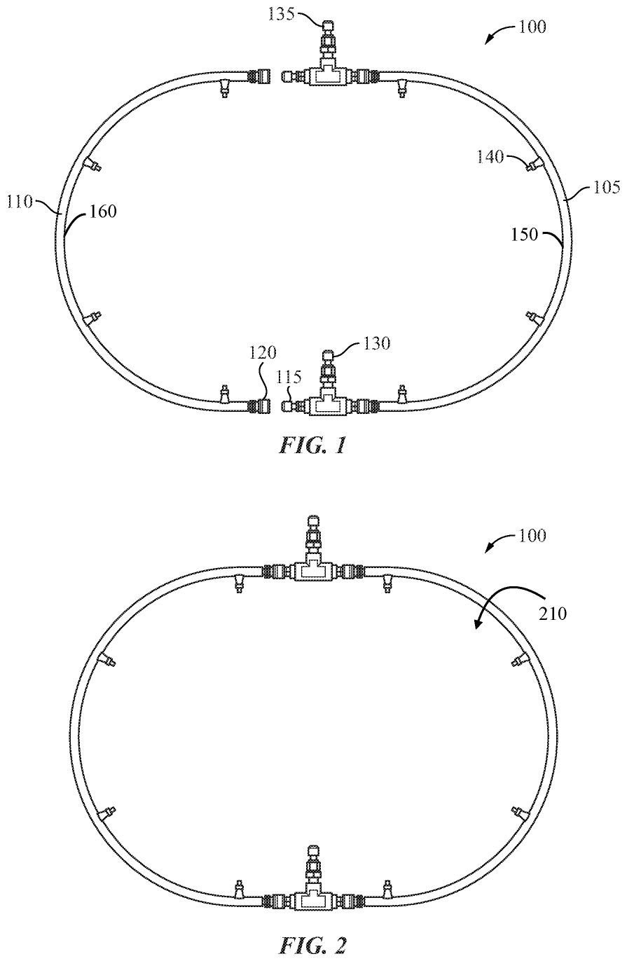

FIG. 1 illustrates a conduit system 100 for transferring a flow of water from the pressure washer to provide a pressurized stream of water to clean the trunk of a tree. The conduit system comprises a first conduit 105 and an optional second conduit 110. The first conduit 105 and second conduit 110 may be connected using a male coupler 115 positioned at each end of the first conduit 105, and female coupler 120 positioned at each end of the second conduit 110. A plurality of spray nozzles 140 are positioned along the length of the first conduit 105 and second conduit 110 to permit the expulsion of water therethrough. The spray nozzles 140 are positioned on the interior circumference 150,160 of the first conduit 105 and second conduit 110 respectively. Receivers 130,135 are in fluid communication with the pressure washer to receive a flow of water therefrom.

In some embodiments, the couplers are quick disconnect couplers commonly utilized in the arts. One skilled in the arts will readily understand that various types of couplers may be employed such that multiple conduits can be connected to one another to increase the circumference of the conduit system to clean a tree trunk having a larger diameter, to increase the volume of water which can be expelled through the spray nozzles, or to provide other benefits. Similarly, the receivers may be quick disconnect couplers to facilitate easy connection or disconnection from the pressure washer.

The conduit system 100 shown in FIG. 1 allows for the conduit to operate in a semi-circular or circular configuration (shown in FIG. 2). The semi-circular configuration removes the second conduit 110 and utilizes only the first conduit 105. In use, the semi-circular configuration may be used to clean tree trunks having a large diameter, or for trees which have multiple trunks extending from a single root system which is common in various palm trees. Each coupler may include a ball valve or similar valve system to impede the flow of water through the aperture of the coupler and allow the semi-circular configuration to function by maintaining sufficient pressure within the conduit to force water through the spray nozzles. FIG. 2 illustrates the conduit system 100 in a circular configuration which may be used for trees having a single trunk, such as the date palm. The interior space 210 is dimensioned to encircle the tree trunk during cleaning.

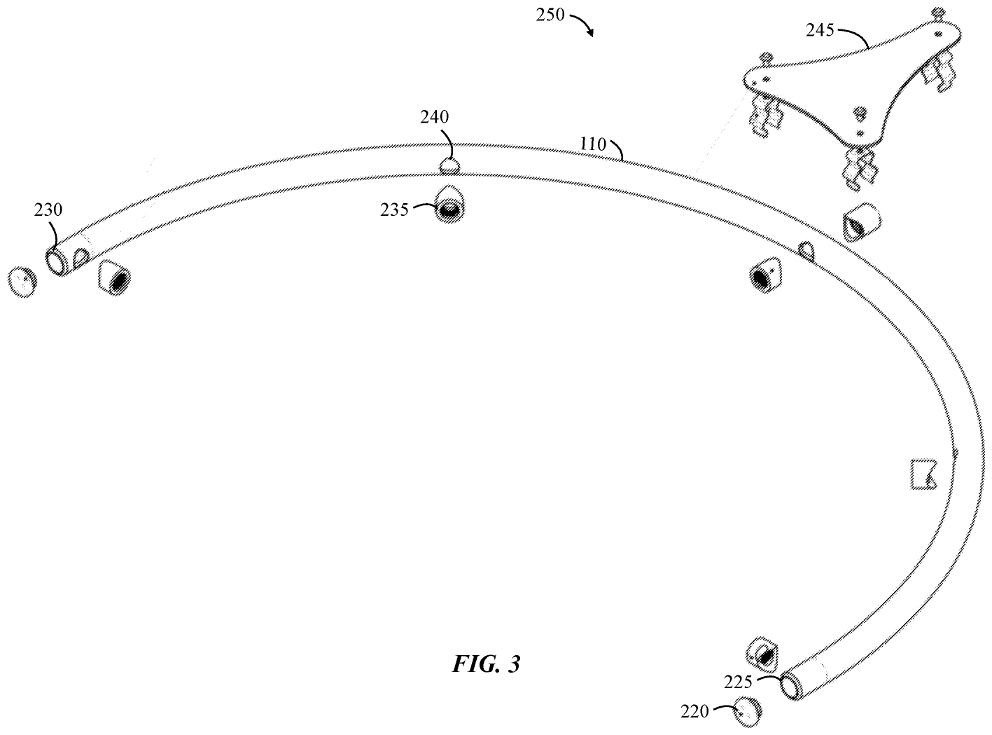

FIG. 3 illustrates a perspective view of the conduit and couplers according to an exemplary embodiment. A plug 220 may be provided at each end 225, 230 of the conduit 110 to stop the flow of fluid therethrough. The plugs 220 are used in a semi-circular configuration to enclose the conduit and force the flow of fluid through the plurality of spray nozzles which receive fluid through each bung 235 provided in fluid communication with each aperture 240 in the conduit. Connection member 245 provides a connection means between the conduit assembly 250 and the pressure washer system.

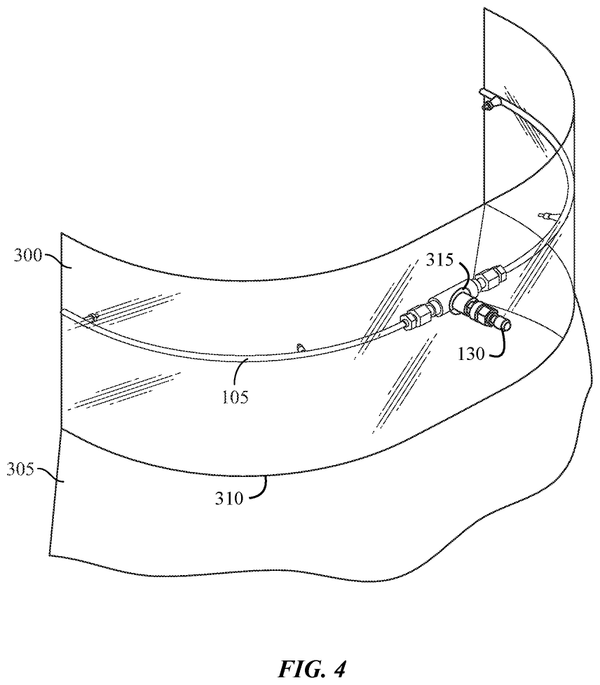

FIG. 4 illustrates the barrier system which forms a barrier to impede water from spraying or flowing in an undesired direction, such as toward the user. For aesthetic purposes, palm trees are often planted at an intersection or along a sidewalk. The barrier may aid in preventing water from spraying into the street, causing a hazard to traffic and pedestrians. The barrier system is comprised of a top portion 300 and a bottom portion 305 extending from a bottom edge 310 of the top portion 300. The top portion 300 may be comprised of an aperture 315 to permit the receiver 130 to extend therethrough.

In some embodiments, the top portion 300 may be constructed of a rigid material such as plexiglass, or similar rigid or semi-rigid material that may attach to the outer circumference of the first conduit 105 (and second conduit 110 although not shown). In some embodiments, the bottom portion 305 is constructed of a flexible material such as a plastic or suitable polymer.

The top portion and bottom portion may be a transparent or semi-transparent material to permit the user to see the tree trunk during the operation of the system.

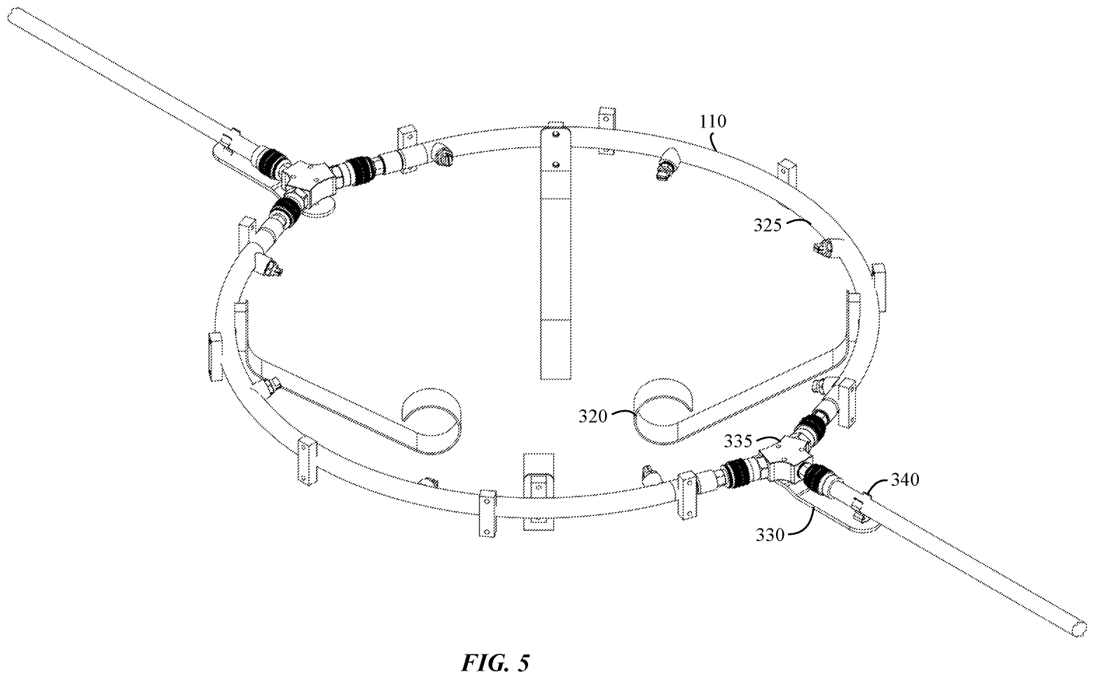

FIG. 5 illustrates the conduit system and tree guides 320 connected to the inner side 325 of the conduit 110. The tree guides extend into the interior space 210 of the conduit 110 to guide the conduit up and down the tree trunk and maintain the conduit 110 and spray nozzles at an adequate distance from the tree trunk surface. A connection member 330 (such as a T-Plate) connects the ends of the conduit to one another and permits fluid flow through a fitting 335. The connection member may also include a clip 340 or similar connection means known in the art to allow for connection to the pressure washer or other water source.

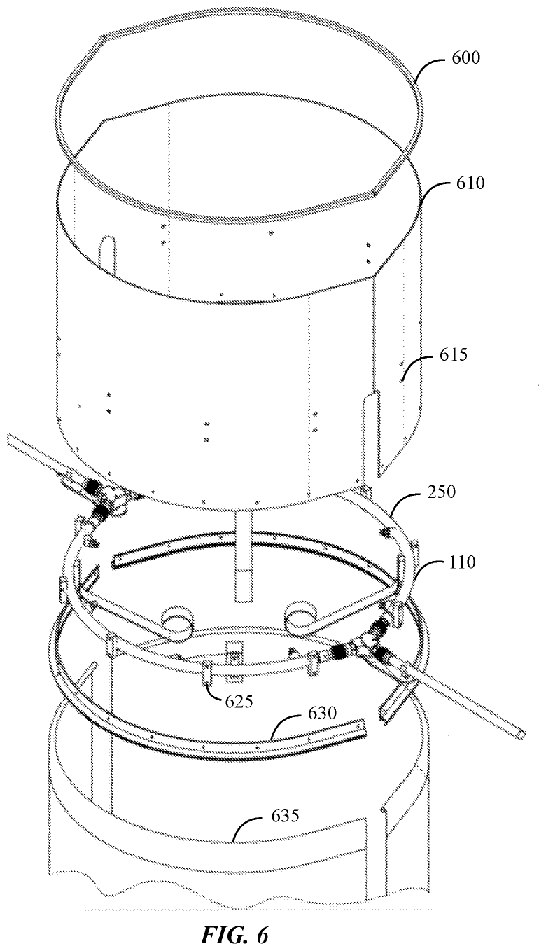

FIG. 6 illustrates an exploded view of the tree trunk cleaning system, according to an exemplary embodiment. An edge molding 600 is positioned at a top end of the barrier 610 which functions as a splash guard to direct the flow of fluid downward, rather than outwards toward the operator or to nearby persons, vehicles, or roadways. The conduit assembly 250 which connects to a central portion 615 of the barrier 610 using members 625 disposed along the length of the conduit 110. An awning extrusion 630 connects the bottom portion of the barrier 610 to a splash skirt 635 which extends downward from the barrier 610 to aid in the prevention of splashing caused during the tree trunk washing process.

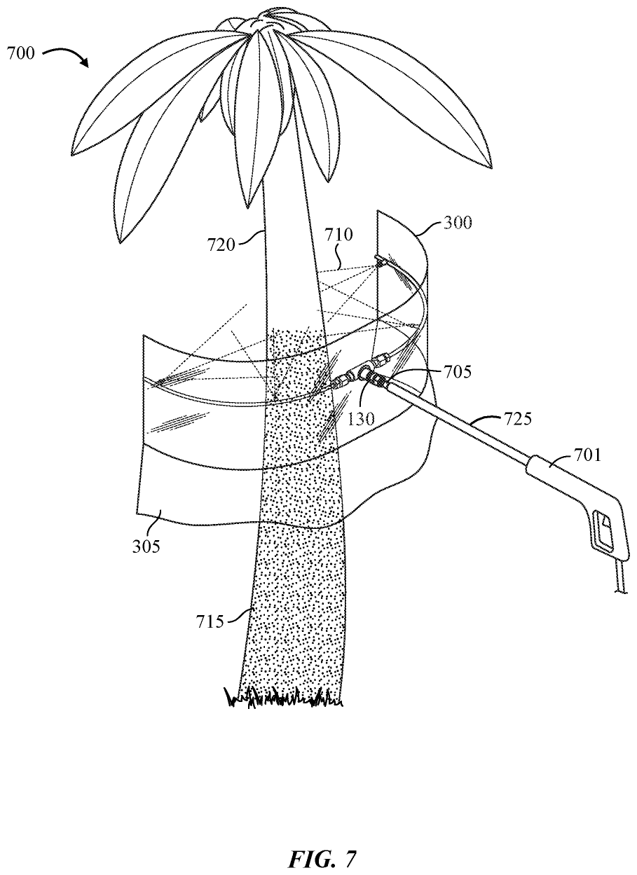

FIG. 7 illustrates the tree trunk cleaning system 700 having a pressure washer 701 releasably engaged with the receiver 130 via a connection 705. The pressure washer 701 is in fluid communication with a water source (not shown). A flow of water 710 is expelled through each spray nozzle to clean undesired material/debris 715 from the tree 720. The top portion 300 and bottom portion 305 of the barrier extends vertically to direct errant water downward to the base of the tree 720. The embodiment illustrated in FIG. 7 shows the conduit in a semi-circular configuration. One skilled in the arts will readily understand that the conduit may be configured in a circular configuration around the tree 720. In some embodiments, member 725 extends between the pressure washer 701 and the connection 705. The member may be telescoping, or otherwise extendable to allow the user to direct the spray of water up and down the height of the tree 720.

In some embodiments, the pressure washer may be a vehicle-mounted pressure washing system. Member 725 may be a hydraulic arm extending between the apparatus and the vehicle mounted system to raise and lower the cleaning apparatus along the length of the tree trunk.

A plurality of pressure washer fittings may be utilized, including 15-degree, 30-degree, 45-degree, or other fittings known in the arts. The pressure washer fittings connect the conduit assembly to the pressure washer to provide a hermetically sealed fitting to direct the flow of water from the pressure washer and through the spray nozzles positioned on the conduit.

In some embodiments, the conduit system is in fluid communication with a pressure washer mounted to a vehicle to perform the task of pressure washing the trunk of a tree, such as a palm tree. Any vehicle type which can mount a pressure washer and/or a water source may be utilized to perform pressure washing procedures. The vehicle may also include a lift to raise and lower the conduit system and/or an operator up and down the height of the tree trunk during operation.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. An apparatus for cleaning the trunk of a tree, the apparatus comprising:
a pressure washer in fluid communication with a water source;
a conduit in fluid communication with the pressure washer to receive a flow of pressurized water expelled therefrom, the conduit arranged in at least a semi-circle to at least partially extend around the diameter of a tree trunk;
a plurality of spray nozzles disposed along the conduit to expel pressurized water from the conduit to clean the tree trunk; and
a barrier connected to the conduit to impede the pressurized water from travelling in an undesired direction.

2. The apparatus of claim 1, wherein the barrier is comprised of a rigid portion connected to the conduit.

3. The apparatus of claim 2, wherein the barrier is further comprised of a flexible portion extending from a bottom edge of the rigid portion.

4. The apparatus of claim 1, wherein a first conduit is comprised of a male coupler at each end, and a second conduit comprised of a female coupler at each end, the male and female couplers to facilitate the connection between one or more conduits to lengthen the conduit.

5. The apparatus of claim 4, wherein the male and female couplers are each complimentary quick disconnect couplers.

6. The apparatus of claim 1, wherein the apparatus is operable in a semi-circular and circular configuration.

7. An apparatus for cleaning the trunk of a date palm tree, the apparatus comprising:
a pressure washer in fluid communication with a water source to supply water to the pressure washer;
a conduit in fluid communication with the pressure washer to receive a flow of pressurized water expelled therefrom, the conduit arranged in at least a semi-circle to at least partially extend around the diameter of a palm tree trunk by a user selectively expelling water through the conduit onto the palm tree trunk to dislodge debris thereon;
a plurality of spray nozzles disposed along the conduit to expel pressurized water from the conduit to clean the tree trunk; and
a barrier connected to the conduit to impede the pressurized water from traveling in an undesired direction, the barrier comprising a top portion connected to the conduit, and a bottom portion connected to a bottom edge of the rigid portion.

8. The apparatus of claim 7, wherein a first conduit is comprised of a male coupler at each end, and a second conduit comprised of a female coupler at each end, the male and female couplers to facilitate the connection between one or more conduits to lengthen the conduit.

9. The apparatus of claim 8, wherein the male and female couplers are each complimentary quick disconnect couplers.

10. The apparatus of claim 9, wherein the apparatus is operable in a semi-circular and circular configuration by connecting one or more of the conduit in series via the male and female couplers.

11. The apparatus of claim 7, further comprising an extendable member connecting the conduit to the pressure washer, wherein the extendable member permits the user to raise and lower the apparatus up and down the height of the tree trunk.

12. The apparatus of claim 7, wherein the top portion of the barrier is constructed of a rigid material.

13. The apparatus of claim 12, wherein the bottom portion of the barrier is constructed of a flexible material.

14. The apparatus of claim 13, wherein the top portion and the bottom portion are each constructed of a transparent material.

15. An apparatus for cleaning the trunk of a date palm tree, the apparatus comprising:
a pressure washer mounted to a vehicle, the pressure washer in fluid communication with a water source to supply water to the pressure washer;
a conduit in fluid communication with the pressure washer to receive a flow of pressurized water expelled therefrom, the conduit arranged in at least a semi-circle to at least partially extend around the diameter of a palm tree trunk by a user selectively expelling water through the conduit onto the palm tree trunk to dislodge debris thereon;
a plurality of tree guides arranged to extend into an interior space of the conduit to retain the conduit at a suitable distance from the palm tree trunk;
a plurality of spray nozzles disposed along the conduit to expel pressurized water from the conduit to clean the tree trunk; and
a barrier connected to the conduit to impede the pressurized water from traveling in an undesired direction, the barrier comprising a top portion connected to the conduit, and a bottom portion connected to a bottom edge of the rigid portion via an awning extrusion.

16. The apparatus of claim 15, wherein the water source is mounted to the vehicle.

17. The apparatus of claim 16, wherein the vehicle is comprised of a lift to lift an operator up and down the height of the tree trunk.

18. The apparatus of claim 15, wherein the apparatus is operable in a semi-circular and circular configuration by connecting one or more of the conduits in series via the male and female couplers.

19. The apparatus of claim 17, further comprising one or more bungs to seal one or more ends of the conduit when operating in a semi-circular configuration.

20. The apparatus of claim 15, further comprising one or more clips to permit the conduit to releasably engage with the pressure washer.
